(19) United States
(12) Patent Application Publication
(10) Pub. No.: US 2013/0004688 A1
(43) Pub. Date: Jan. 3, 2013

(54) METHOD FOR JOINING HOLLOW GLASS BODIES AND DISCHARGE VESSEL

(75) Inventors: Ruediger Diekmann, Dillingen (DE); Andreas Engel, Schwabmuenchen (DE); Klaus Lemdche, Grossaitingen (DE); Bernd Pilhoefer, Graben (DE); Reinhold Schmidt, Augsburg (DE)

(73) Assignee: OSRAM AG, Muenchen (DE)

(21) Appl. No.: 13/580,177

(22) PCT Filed: Mar. 8, 2011
(86) PCT No.: PCT/EP2011/053470

§ 371 Date: Aug. 21, 2012

(30) Foreign Application Priority Data
Mar. 26, 2010 (DE) 10 2010 003 348.0

(51) Int. Cl. H01J 9/26; H01J 61/32; C03B 23/217

(52) U.S. Cl. 428/34.4; 65/55

(57) ABSTRACT

In various embodiments, a method for producing a fluid connection between hollow glass bodies is provided. The method may include molding a joining region on each of the glass bodies; at least partially opening the joining regions; mutually positioning the glass bodies in the region of the joining regions; and joining the glass bodies.

The present invention relates to a method for producing a fluid connection between hollow glass bodies and to a discharge vessel having at least two hollow glass bodies that are in fluid communication with each other.

In the production of coherent glass vessels, instances of which can also include discharge vessels for gas-discharge lamps, different hollow glass bodies—future vessel parts—have to be joined in such a way as to enable the individual glass bodies' interiors to intercommunicate. It is therefore necessary to join the hollow glass bodies in such a way that fluid will be able to communicate between the individual glass bodies. The connection that is produced must at the same time be sufficiently robust and strain-resistant.

Examples of joins of such kind between glass bodies are what are termed “kiss joints” between individual tubes of the discharge vessels of compact low-pressure discharge lamps. They are produced by heating joining regions, applying compressed air from the inside of the tubes, and bringing the heated joining regions close together, with the heated material opening under the impact of the compressed air and bulging outward. The heated, outwardly displaced material combines and fuses when the tubes are brought close together. A fluid connection is left between the two tubes via the previously produced openings when the tubes are conjoined and fused. The impact of the compressed air can be sustained during the joining process to support defined shaping of the fluid connection. Kiss joints are described in, for example, EP 0 267 340 A1. It is a technique that can be applied also to the production of any other joints between hollow glass bodies with its being a requirement therein to produce a fluid connection between the glass bodies.

A disadvantage of kiss joints is that they are shaped having little definition and their behavior and stability will be adversely affected in particular when there are coatings on the inside of the glass bodies. For example a fluorescent coating is generally provided on the inside of discharge vessels for discharge lamps. Said coating transforms radiation produced in the UV wavelength range while the discharge lamp is operating by a gas mixture enclosed within the discharge vessel into the visible wavelength range. What is termed a protective layer that prevents mercury or other constituents of the gas mixture enclosed within the discharge vessel from diffusing into the glass is furthermore frequently applied to the inside of the discharge vessels between the vessel wall and fluorescent coating. Whereas the presence of a fluorescent coating on the inside of the discharge vessel will have no substantial impact on a joint's behavior, owing to its different surface tension the presence of a protective layer causes material therefrom to be incorporated in the fusion when the discharge vessels are being joined, which results in a less break-resistant fusion. That applies also to other coatings whose surface tension is in particular such that if the glass-body wall tears open during heating, the inside that is coated will bulge outward whereas it will bulge inward if inner walls are non-coated.

These disadvantages in the production of fluid connections between hollow glass bodies have hitherto been obviated by not using any of the relevant coatings or by removing them from specific regions before the joint is produced. In the case of discharge vessels for gas-discharge lamps that means that either no protective layers are used or the protective layer is wiped away, meaning removed from the joining region, prior to joining. Wiping-away is a costly process, though, and one that is often not possible specifically in the case of discharge vessels having a more complex geometry.

The object of the present invention is therefore to provide a method for producing fluid connections between hollow glass bodies through which method the above-described disadvantages can be reduced. Also presented is a discharge vessel having at least two hollow glass bodies that are in fluid communication with each other and in which the joint between the glass bodies has sufficient strength.

Said object is achieved by means of a method for producing fluid connections between hollow glass bodies and by means of a discharge vessel having at least two hollow glass bodies that are in fluid communication with each other having the features of independent claims 1 and 13 respectively.

Developments and advantageous embodiments of the method for producing fluid connections between hollow glass bodies or, as the case may be, the discharge vessel having at least two hollow glass bodies that are in fluid communication with each other are described in the dependent claims.

### EXEMPLARY EMBODIMENTS

Various embodiments of the method for producing a fluid connection between hollow glass bodies include
Molding a joining region on each of the glass bodies
At least partially opening the joining regions
Mutually positioning the glass bodies in the region of the joining regions
Joining the glass bodies.

A basic idea underlying various embodiments is that the shape of the joint can be influenced by selectively molding the joining regions especially at an early stage. When the joining regions are subsequently being partially opened it will then be possible to select the partial region in which an opening is to be produced, which will later positively influence the fluid connection's shape when the glass bodies are joined. The aim is for the glass bodies to be joined particularly in a gas-tight manner with the production of a fluid connection, which means that fluid will be able to communicate between interiors of the glass bodies (fluid can also be understood to mean gas), while communication with the external regions will have been prevented at least via the joint.

In an embodiment of the method for producing a fluid connection between hollow glass bodies, the joining region may be shaped having a central and a circumferential section and projecting from the surface of the glass body. A spacing from the glass bodies' external walls can be ensured thereby so that no unnecessary and possibly damaging contacting will occur between said bodies when they are being joined. The joining region can particularly preferably be shaped having a flat central section. Such a section will allow a clearly defined region to be established in which the fluid connection is subsequently to be produced. The flat central section's area can here substantially define the region available for the fluid connection's formation. Especially two flat central sections can be joined in a particularly simple and defined manner.

In an embodiment of the method for producing a fluid connection between hollow glass bodies the joining region can be shaped by heating regions of the glass body, building up pressure in the glass body, and using a negative mold for shaping. Heating can therein be performed using naked flames, an infrared source, or other known methods. A pressure can be built up in an interior space of the glass body after heating and the glass body then shaped against a negative mold. The glass body can therein be positioned against a preferably likewise heated negative mold. Positioning can be understood as closing a plurality of parts of a negative mold around the glass body. It is also possible to position the glass body against a negative mold in the form of, for example, a model or, as the case may be, matrix only partially enclosing the glass body. A slight overpressure is advantageously built up in the glass body's interior prior to molding and in particular prior to positioning against the negative mold because it will then be ensured that the heated glass-body region will be sufficiently stable on making contact with regions of the negative mold. Pressure can be built up after positioning so that the glass body's heated and consequently deformable region will be shaped in the negative mold. The joining region can in particular be shaped in such a way as to produce at least in regions a flat area establishing a defined region in which the joining regions can be partially opened and/or the glass bodies can be joined.

In an embodiment of the method for producing a fluid connection between hollow glass bodies the joining region can be at least partially opened particularly in a central section thereof by heating then blowing a hole. A flame, for instance, can be used for heating. A hole can be blown by applying overpressure to an interior space of the glass body or through the defined application of compressed air within the heated region. The compressed air can therein be applied both from an inner and an outer side of the glass body by means of, for example, a suitable nozzle. Opening can take place preferably only in an internal partial region of the joining region, in particular the central section, so as to leave room for joining the glass bodies via the joining region.

In an embodiment of the method for producing a fluid connection between hollow glass bodies, connecting material can be applied in the region at least of one of the joining regions of the hollow glass bodies. That can be done preferably before the joining regions are at least partially opened. The connecting material can consist preferably of the same material as the glass bodies or of a material that will bond well with the materials forming the glass bodies particularly through fusing. On the one hand the joining region—which can have a reduced wall thickness particularly when shaped in a negative mold—can be stabilized through the application of the connecting material. Additional stabilizing can also be advantageous particularly when the joining regions are partially opened by blowing a hole; the connecting material can here also be provided particularly in edge regions of the holes requiring to be opened out or, as the case may be, in a region of the joining region's circumferential section. On the other hand, by applying connecting material additional material can be provided for joining the two glass bodies, which in particular will allow greater flexibility in setting the precise joining shape with increased final strength. Joints can thus in particular also be produced close to glass-body ends at which, especially if shaping is by means of ablating, there will be less original material since sufficient material will be available owing to the connecting material. The term “applying” can also be understood as including sticking, pasting, or fusing the connecting material onto the joining region. The connecting material can be applied evenly or in any fashion. The connecting material can preferably have a substantially flat contact area via which it can be bonded particularly simply to the other glass body or to a connecting material provided thereon.

In an embodiment of the method for producing a fluid connection between hollow glass bodies, joining the glass bodies may include fusing the connecting material. It is thus possible, for example, at a first step to stick the heated connecting material together particularly by heating the applied connecting material and in particular by heating contact areas thereof and then to fuse the connecting materials by heating the thus bonded glass bodies again particularly in the joining regions. Heating can therein again be performed preferably using naked flames. The connecting material can therein simultaneously be fused with regions of the joining regions and with a connecting material that may have been applied to the other glass body. What is advantageous therein is that the glass bodies will be joined preferably exclusively via connecting material whose connecting properties can be selected appropriately. Thus the glass bodies will have been joined indirectly via the connecting material while the material of the respective glass bodies will have been directly joined only to the connecting material but not to the other glass body.

In an embodiment of the method for producing a fluid connection between hollow glass bodies, the connecting material can be applied to the joining region in the form of a sleeve, particularly a ring. What is advantageous therein is that a sleeve sets a defined shape within which the joining region can be partially opened. Appropriately selecting a wall thickness and sleeve height will enable the distance between the glass bodies requiring to be joined having an ensured fluid connection to be set very precisely, and so too an attainable wall thickness in the region of the fluid connection, which in turn has an impact on the joint's strength.

In an embodiment of the method for producing a fluid connection between hollow glass bodies, an inner region of the sleeve made of connecting material can be applied to a circumferential section of the joining region. Thus, for example, a sleeve can be applied to a joining region in such a way as to encompass an external section projecting from the glass body and in particular to protrude or, as the case may be, project from a central section so that when the glass bodies are subsequently joined via the connecting material, for example a joining region—having a mirror-inverted shape—of a second glass body can fit into the sleeve. Joining can alternatively be by way of another, corresponding sleeve on a second glass body. What is particularly advantageous therein is that it can be ensured thereby that the glass bodies are joined substantially only via the sleeves having known and easy-to-set material properties. Applying an inner region of the sleeve to a circumferential section of the joining region offers the additional advantage that the joining region will then be capable of being additionally stabilized. That will have a positive effect in particular during ensuing partial opening of the joining region in the central section.

In an embodiment of the method for producing a fluid connection between hollow glass bodies, molding the joining region and applying the connecting material can be performed at a single step. Thus, for example, the connecting material can be placed in a negative mold before the joining region is shaped against it. While the joining region is being shaped, the possibly likewise heated connecting material will adhere to the joining region's regions into which it comes into contact. The method can in that way be further simplified.

In an embodiment of the method for producing a fluid connection between hollow glass bodies, the connecting material can fuse with the glass bodies when they are being joined. The connecting material and glass body can alternatively fuse already when the connecting material is being applied. Just adhering or sticking during the application process can, though, in itself suffice to stabilize the joining region. Both the connecting material and respective glass bodies and the respective connecting material applied to the glass bodies can particularly advantageously fuse. A plurality of joining operations can thus advantageously be combined within a single step of the method.

In an embodiment of the method for producing a fluid connection between hollow glass bodies, a flow can be maintained between the glass bodies during the joining process, and in particular during fusing. It can be advantageously ensured thereby that partial openings in the joining regions will remain open during the joining process and not collapse or fuse shut.

In an embodiment of the method for producing a fluid connection between hollow glass bodies, at least one of the glass bodies can have a coating, particularly a protective layer, on an inner side. By providing the connecting material in the region of the joining regions it can here be advantageously ensured that the glass bodies will be joined only via substantially non-coated contact areas. These can be in particular the glass bodies' outer sides and the connecting material. The disadvantages due to contaminating of the joint between the glass bodies by parts of a coating on an inner side of the glass bodies can be obviated thereby. When the connecting material is applied appropriately it can be ensured that even when the joining regions are partially opened a joint will be produced only via the connecting material despite the effects due to the coating's surface tension. Thus, for example, a sleeve of the connecting material can be selected to project in such a way that the material will not extend across the sleeve's entire inner region or not even touch it when the joining region is partially opened. Partial opening can in particular be effected such that the opening does not extend into a region that comes into contact with the connecting material. Thus, for example, the opening can have been produced only in an inner partial region of the central region, with an external region—bordering on the connecting material—of the central region remaining intact. It can be ensured thereby that no parts of the coating will be contained in the joint when the connecting material is fused.

In an embodiment of the method for producing a fluid connection between hollow glass bodies, the method can serve to produce a discharge vessel for a gas-discharge lamp. What can preferably be used in that case are tubular glass bodies for example split off from a long glass tube possibly already provided with a protective layer, for example AlonC, and a fluorescent coating. Splitting-off can therein be performed in such a way that a closed surface coated on the inside is formed at the head end. On the opposite side, splitting-off is performed in that case preferably in such a way that the glass tube remains open. What can also be understood here is that the interior will remain accessible by way of a pumping lead via which, generally, the lamp vessel is rinsed and filled with a gas mixture. Thus, for example, a build-up of pressure in the glass body can take place that can be used when the joining region is being molded or when holes are being blown. When a joining region has been molded on the glass tubes, preferably after connecting material has been applied and in particular a central region of the joining region has been partially opened, the glass tubes can be joined via the connecting material with a fluid connection being produced to the discharge vessel. When a discharge vessel of such kind is being made, more than two glass bodies can also be joined with the production of a fluid connection, the steps then having to be repeated accordingly. A discharge vessel can then be produced by incorporating electrodes which, for example, can be arranged on what are termed glass plates and contacted via power supply lines. A further joint can therein have been produced via, for instance, a pumping lead for rinsing and filling the discharge vessel in an ensuing operation. Any other glass vessels where different glass bodies are in fluid communication among themselves can, though, also be produced by means of the method.

Various embodiments of the discharge vessel having at least two hollow glass bodies that are in fluid communication with each other are characterized in that the at least two glass bodies are joined via connecting material. The at least two glass bodies therefore have a joint via connecting material via which joint they are in fluid communication with each other. The discharge vessel can, though, also have more than two hollow glass bodies that are in fluid communication with each other and are joined via connecting material.

A notion underlying various embodiments is that the at least two glass bodies are joined particularly in a gas-tight manner by means of a connecting material. That offers the advantage that the connecting material's parameters can be selected such as to make a good joint possible between the glass bodies that displays sufficient strength and tightness, with a fluid connection between the glass bodies being produced at the same time. Glass whose material parameters are the same as or similar to those of the glass used for the glass bodies is preferably provided as the connecting material. The connecting properties—strength in particular as well as the distance between the glass bodies in the joined condition—can be further selectively influenced by appropriately selecting the amount of connecting material used. Because additional connecting material is applied, the joint between the glass bodies can be produced at any locations, in particular also at end regions thereof at which the wall thickness is usually less and a joint used to be provided only with difficulty owing to insufficient material.

In an embodiment of the discharge vessel the connecting material can be embodied in the form of sleeves and in particular rings. That offers the advantage that sleeves of such kind are easy to produce having precisely defined properties such as diameter, wall thickness, and height and can readily be matched in shape to the glass bodies. Sleeves in particular offer the additional advantage of being intrinsically stable and easy to apply and so will further stabilize the joint. The connecting material can also be an assemblage of a plurality of sleeves which can in particular have been fused one upon the other as is done when the connection is produced by joining two glass bodies having sleeves each applied in joining regions.

In an embodiment of the discharge vessel the glass bodies can substantially each have been joined to an inner region of the connecting material. That offers the advantage that in particular an outer side of the glass bodies can have been joined to the connecting material, with the materials' parameters being able to be mutually well accommodated. The connecting material can in particular have been arranged such that the joint is produced only via the connecting material, so it can, for example, project relative to the joining region formed on the glass body. Contaminating of the joint by any coatings there may be on an inner side of the glass bodies can be effectively obviated thereby and a stable joint produced.

In an embodiment of the discharge vessel at least one of the at least two glass bodies can be coated on an inner side with a protective layer. Alongside a fluorescent coating, both or all the glass bodies can in particular have on their inside a protective layer that makes more economical mercury dosing possible in the gas mixture requiring to be provided in a discharge lamp as well as reducing the discharge vessel's contamination by diffused mercury.

### SHORT DESCRIPTION OF THE DRAWINGS

Various exemplary embodiments of the inventive solution are explained in more detail below with the aid of the drawings. The same reference numerals have been used in all figures for elements that are the same kind or function in the same way.

The figures are:

FIG. 1 a flowchart of an exemplary embodiment of a method for producing a fluid connection between hollow glass bodies;

FIG. 2a a schematic oblique view of a glass-body section having a joining region according to a first exemplary embodiment;

FIG. 2b a schematic of a development of the glass-body section as shown in FIG. 2a;

FIG. 2c a schematic of a development of the glass-body section as shown in FIG. 2b;

FIG. 2d a schematic top view of two glass-body sections as shown in FIG. 2c requiring to be joined;

FIG. 2e a schematic of a joining of two hollow glass-body sections with simultaneous production of a fluid connection according to the first exemplary embodiment;

FIG. 2f a schematic of an alternative arrangement of the joining of two hollow glass-body sections with simultaneous production of a fluid connection according to the first exemplary embodiment;

FIG. 3 a schematic of a hollow glass-body section having connecting material applied in the shape of a ring according to another exemplary embodiment;

FIG. 4a a schematic top view of a hollow glass-body section having connecting material applied in the shape of a ring according to another exemplary embodiment;

FIG. 4b a schematic of a cross-section through the glass-body section shown in FIG. 4a along an axis of intersection A-A;

FIG. 4c a schematic of a joining of two hollow glass-body sections as shown in FIG. 4b with simultaneous production of a fluid connection along an axis of intersection A-A;

FIG. 5 a schematic of a top view of a discharge-vessel prestage according to another exemplary embodiment.

### DETAILED DESCRIPTION OF EXEMPLARY EMBODIMENTS

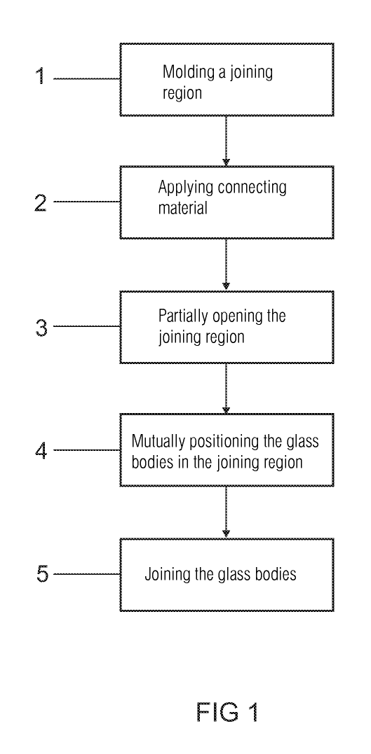

FIG. 1 is a schematic of a flowchart of an exemplary embodiment of a method for producing a fluid connection between hollow glass bodies. The method according to the exemplary embodiment includes the steps of molding a joining region on each of the glass bodies (1), applying connecting material (2), at least partially opening the joining regions (3), mutual positioning the glass bodies in the region of the joining regions (4), and joining the glass bodies (5). Further advantageous intermediate steps can be inserted between the steps of the embodiment shown or the steps can be modified. In particular the fifth step (5) may include joining the glass bodies via the connecting material in such a way that the glass bodies will each fuse with the connecting material and the connecting material will itself fuse together.

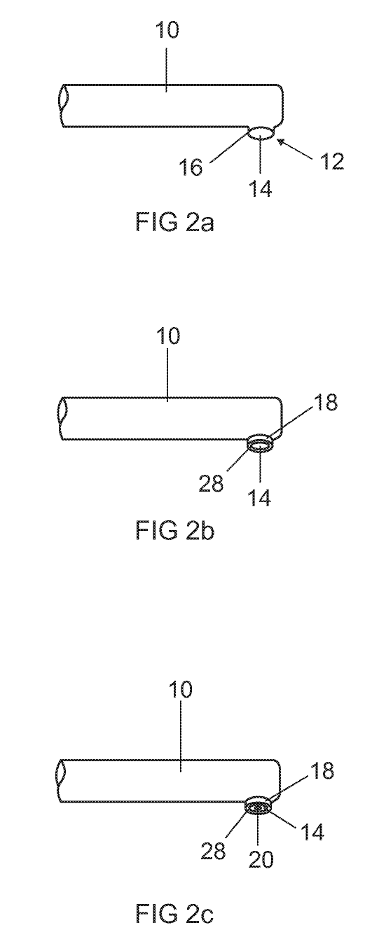

A first exemplary embodiment of the method will be explained in more detail with the aid of FIGS. 2a to 2c. FIG. 2a is a schematic oblique view of a first glass-body section of a hollow glass body 10 having a joining region 12 according to a first exemplary embodiment. Joining region 12 is shaped as projecting from a surface of glass body 10 and has an in particular flat central section 14 and a circumferential section 16. Shaping of joining region 12 can be prepared in particular by heating the relevant region of glass body 10, building up pressure on an inner side of glass body 10 by means of, for instance, appropriate gas-tight contacting with a pressure source or selective impacting by a pressure source, for example by inserting a compressed-air nozzle and directing the air onto the relevant region. Joining region 12 can then be shaped by positioning an in particular preheated negative mold against it and increasing the pressure.

FIG. 2b shows the glass-body section of hollow glass body 10 as shown in FIG. 2a after the application of connecting material in the form a glass ring 18. Glass ring 18 has here been applied to circumferential section 16 of joining region 12; it can in particular have been stuck into position for example by heating both glass ring 18 and circumferential section 16. Selecting the respective temperatures appropriately will result during mutual positioning not in a fusing but only in sticking action, as a result of which sufficient stability will already have been ensured for the ensuing steps of the method. Glass ring 18 is here positioned preferably such as to project beyond central section 14 of joining region 12. It is thereby possible to make a sufficient quantity of connecting material available and to ensure that the joint will be produced only via the connecting material. A front face—facing away from glass body 10—of glass ring 18 therein forms a front contact area 28.

FIG. 2c shows the glass-body section of hollow glass body 10 as shown in FIG. 2b after joining region 12 has been partially opened. An opening 20 was here produced in central section 14, specifically preferably by heating regions of central section 14 by means particularly of a naked flame. The material of central section 14 melts under the effect of the heat and opens out; that process can be supported by the impact of an air stream. Pressure can preferably be applied here from inside the glass body 10 by inserting a compressed-air nozzle. The same nozzle can be used as in molding joining region 12. An overpressure causing the heated and softened material of central section 14 to inflate can alternatively also be applied inside glass body 10. The pressure effect in particular by way of a compressed-air nozzle could also be provided from outside. That process is referred to overall as hole blowing. Previously applied glass ring 18 therein stabilizes joining region 12 which heating has destabilized. Hole blowing is performed preferably from an inner side of glass body 10; glass ring 18 is therein positioned such that outwardly turned material of glass body 10 will not reach as far as glass ring 18 while central section 14 is being opened. It can thereby be ensured that contaminants due to any coatings that may have been applied on the inside of the glass body will not extend into the region via which glass bodies 10, 10′ will subsequently be joined.

FIG. 2d shows glass-body sections of hollow glass body 10, as shown in FIG. 2b, and of a corresponding other glass body 10′ facing each other in joining region 12. Contact areas 28 of glass rings 18, 18′, preferably not contaminated by material of glass bodies 10, 10′, are therein positioned such as to be mutually opposite. Preferably already heated glass rings 18, 18′ are further heated in that position by means particularly of naked flames, joined together or, as the case may be, connected, and then fused. Outer sections 16 of joining regions 12 are preferably fused with inner regions of glass rings 18, 18′ simultaneously with the fusing together of glass rings 18, 18′. What results is joint 22 as shown in FIG. 2e. A flow is maintained between the glass bodies during the fusing process, preferably during joining and particularly during fusing. It can be ensured thereby that partial openings 20 in joining regions 12 will also remain open during the joining process and not collapse or fuse shut. A fluid connection that is stable and in particular gas-tight and obviates the disadvantages of the prior art will be produced by means of joint 22 between hollow glass bodies 10 and 10′. The distance between glass bodies 10, 10′ can be set by appropriately selecting the height of glass rings 18, 18′. If joining regions 12 are arranged appropriately, then providing connecting material in the form of glass rings 18 will in particular also enable joint 22 to be embodied closer to the end of glass bodies 10, 10′ as shown schematically in FIG. 2f.

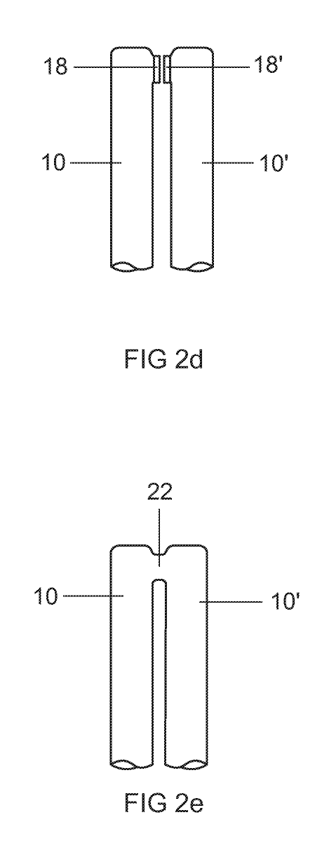

FIG. 3 is a schematic detail of a hollow glass-body section 10 having an applied glass ring 18 according to another exemplary embodiment. Elements that correspond have been assigned the same reference numerals as in the first exemplary embodiment. By being placed and heated in a negative mold, glass ring 18 can also be applied simultaneously with molding of joining region 12 having a central section 14 and a circumferential section 16. It will in particular be ensured when glass ring 18 is being applied that between a contact area 28 of glass ring 18 and central section 14 a projection 26 will remain that is dimensioned such as to reliably prevent contact area 28 and adjacent regions of glass ring 18 from being contaminated during hole blowing.

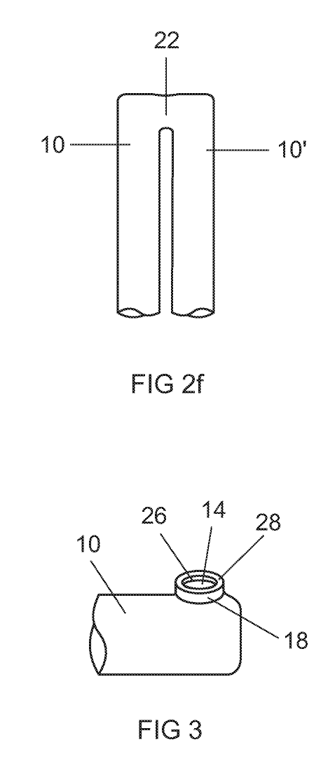

FIG. 4a is a schematic top view of a hollow glass-body section 10 having an applied glass ring 18 as shown in FIG. 3 after hole blowing. What is shown here is how the material of glass body 10 turns outward during hole blowing, particularly when it has an applicable coating on its inside, and forms a bead 24 on central section 14. Suitably shaping/arranging opening 20 will in particular ensure that glass ring 18 is not contaminated with bead material possibly containing coating material. A good joint between glass body 10 and glass ring 18 can be ensured by means of sticking and subsequent fusing because glass ring 18 and the section of joining region 12 coming into contact with glass ring 18 are free from contaminants.

FIG. 4b is a schematic of a cross-section through glass-body section 10 shown in FIG. 4e along an axis of intersection A-A. It can be seen therein that bead 24 does not extend into a region of glass ring 18 and that in particular a non-covered projection 26 is retained via which joint 22 can be produced along with another glass body 10′ using suitable connecting material, as shown schematically in FIG. 4c along the axis of intersection A-A. Beads 24 remaining in joint 22 will cause no disruption in the case of a discharge vessel having a discharge path forming in the region of joint 22 because the path will form substantially centrally, meaning in the region of openings 20. For the discharge vessel's uniform illumination it is in this connection more important to be able to displace joint 22 as far as the end of glass bodies 10, 10′ owing to the use of connecting material, as shown in, for example, FIG. 2f.

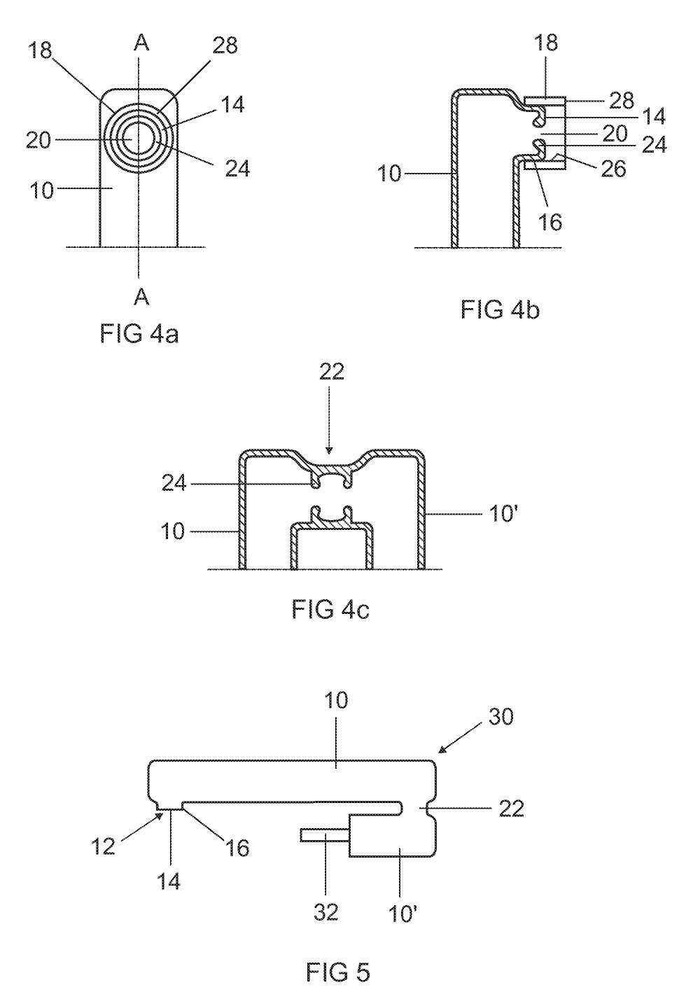

FIG. 5 is a schematic top view of a discharge-vessel prestage 30 according to another exemplary embodiment. For discharge-vessel prestage 30, two tubular hollow glass bodies 10, 10′ have been joined via a joint 22 with a fluid connection being produced.

Glass body 10′ has therein been joined at one end to a pumping lead 32 that enables pressure to be built up in an interior of discharge-vessel prestage 30 for ensuing hole blowing, for example. The other front faces of tubular glass bodies 10, 10′ have been sealed in a gas-tight manner by being appropriately split off under the application of heat. A coating on an inner side of glass bodies 10, 10′ is therein retained. Molded out of a left-hand lateral end of glass body 10 is a joining region 12 that has a central section 14 and a circumferential section 16 and to which connecting material can subsequently be applied for producing another joint 22 to another glass body that can be embodied as being the mirror inversion of glass body 10′. Discharge lamps of such kind are used, for example, for seamlessly illuminating ribbons and edges because in their case a discharge path extends substantially along the entire length of glass body 10 and there are no dark ends on the end faces where in conventional rod-shaped gas-discharge lamps the electrodes are located. It is here particularly advantageous that joints 22 can be produced very close to the front ends of glass body 10 owing to the use of connecting material.

### CONCLUDING STATEMENT

The method for producing a fluid connection between hollow glass bodies and the discharge vessel having at least two hollow glass bodies that are in fluid communication with each other were described with the aid of some exemplary embodiments to illustrate the underlying notion. The exemplary embodiments are not therein limited to specific feature combinations. Even though some features and embodiments have been described only in connection with one particular exemplary embodiment or individual exemplary embodiments, they can in each case be combined with other features from other exemplary embodiments. It is also conceivable to omit or add individual features or particular embodiments presented in exemplary embodiments provided the general technical doctrine remains realized.

Even though the steps of the method for producing a fluid connection between hollow glass bodies have been described in a specific sequence, each of the methods described in this disclosure can of course be performed in any other, meaningful sequence, with its also being possible for steps of the method to be omitted or added provided that no departure will be made thereby from the basic notion underlying the technical doctrine described.

### LIST OF REFERENCES

0 Molding a joining region
2 Applying connecting material
3 Partial opening of the joining region
4 Mutual positioning the glass bodies in the joining region
5 Joining the glass bodies
10, 10′ Hollow glass body
12 Joining region
14 Central section
16 Circumferential section
18, 18′ Glass ring
20 Opening
22 Joint
24 Bead
26 Projection
28 Contact area
30 Discharge-vessel prestage
32 Pumping lead

1. A method for producing a fluid connection between hollow glass bodies, the method comprising:
molding a joining region on each of the glass bodies;
at least partially opening the joining regions;
mutually positioning the glass bodies in the region of the joining regions;
joining the glass bodies.

2. The method as claimed in claim 1,
with the joining region being shaped having a central section and
a circumferential section and projecting from the surface of the glass body.

3. The method as claimed in claim 1,
with the joining region being molded by heating regions of the glass body, building up pressure in the glass body, and using a negative mold for shaping.

4. The method as claimed in claim 1, with the joining region being at least partially opened by means of heating and hole blowing.

5. The method as claimed in claim 1, further comprising applying connecting material to the region of the joining regions.

6. The method as claimed in claim 5,
wherein joining comprises fusing the connecting material.

7. The method as claimed in claim 5,
with the connecting material being applied to the joining region in the form of a sleeve.

8. The method as claimed in claim 5, with an inner region of the sleeve being applied to a circumferential section of the joining region.

9. The method as claimed in claim 5, with joining region being shaped and the connecting material applied at a single step.

10. The method as claimed in claim 5, with the connecting material fusing with the glass bodies when the glass bodies are joined.

11. The method as claimed in claim 5, with at least one of the glass bodies having a coating on an inner side.

12. The method as claimed in claim 1 used for producing a discharge vessel for a gas-discharge lamp.

13. A discharge vessel, comprising:
at least two hollow glass bodies that are in fluid communication with each other,
with the at least two glass bodies having been joined via connecting material.

14. The discharge vessel as claimed in claim 13,
with the connecting material being embodied like a sleeve.

15. The discharge vessel as claimed in claim 13,
wherein the glass bodies are in each case joined to an inner region of the connecting material.

16. The discharge vessel as claimed in claim 13,
wherein at least one of the glass bodies has been coated on an inner side with a protective layer.

17. The method as claimed in claim 5,
wherein the applying connecting material to the region of the joining regions is carried out before the joining regions are partially opened.

18. The method as claimed in claim 7,
with the connecting material being applied to the joining region in the form of a ring.

19. The method as claimed in claim 11,
wherein the coating is a protective layer.

20. The discharge vessel as claimed in claim 14,
with the connecting material being embodied like a ring.
